(19) United States
(12) Patent Application Publication
(10) Pub. No.: US 2019/0097265 A1
(43) Pub. Date: Mar. 28, 2019

(54) PHASE-CHANGE NANOPARTICLES FOR LI-ION BATTERY SAFETY

(71) Applicants: ARASH TAKSHI, Tampa, FL (US); MANOJ KUMAR RAM, Palm Harbor, FL (US)

(72) Inventors: ARASH TAKSHI, Tampa, FL (US); MANOJ KUMAR RAM, Palm Harbor, FL (US)

(73) Assignee: University of South Florida, Tampa, FL (US)

(21) Appl. No.: 16/133,020

(22) Filed: Sep. 17, 2018

Related U.S. Application Data
(60) Provisional application No. 62/563,305, filed on Sep. 26, 2017.

(51) Int. Cl. H01M 10/0525; H01M 10/61; H01M 10/0565; H01M 4/02

(52) U.S. Cl. CPC H01M 10/0525; H01M 4/02; H01M 10/0565; H01M 10/61

(57) ABSTRACT

Methods and devices for controlling the temperature of a Li-ion battery cell are provided. A method can included combining the electrolyte and electrode components of a Li-ion battery with nanoparticles comprising of a phase change material with a melting point of 80° C. or greater, encapsulating the phase change material in an encapsulating material that has a melting point of 120° C. or greater.

### CROSS-REFERENCE TO RELATED APPLICATION

This application claims the benefit of U.S. Provisional Application Ser. No. 62/563,305, filed Sep. 26, 2017, the disclosure of which is hereby incorporated by reference in its entirety, including all FIGURES, tables, and drawings.

### BACKGROUND

Among different types of electrical charge storage devices, lithium ion (Li-ion) batteries are the dominant devices for various applications ranging from small portable electronics (e.g. cell phones and laptops) to electric/hybrid vehicles. This is particularly due to the high energy density and rechargability of the Li-ion batteries. The energy density in rechargeable Li-ion batteries can reach up to 0.9 MJ/kg which is 5 times higher than lead-acid batteries. Since batteries are often the heaviest component in almost all portable electronics, the high energy density is a critical factor for making light weight devices. For that reason, despite the higher cost, Li-ion batteries have been widely used in many recent electronic products. Also, Li-ion batteries are the best choice for electric vehicles when a low weight battery with a high storage capacitance is required.

While the superiority of the energy density in Li-ion batteries has justified their higher cost, the main drawback today is the safety of the batteries. There are numerous reported incidents about combusted Li-ion batteries in an electronic device. In a few cases, the device users were injured due to battery combustion.

The mechanism of charge storage in Li-ion batteries dictates the structure of the battery, especially the electrodes' structure. For efficient charge storage and the battery lifetime, the charging process is very critical; particularly the current density during the charging cycle has to be limited. Otherwise, the electrode structure of the battery would be damaged. Also, such damage can occur in the event that a battery is short circuited. While a damaged electrode can potentially be a hazard for the battery, a prominent reason for combustion of a battery is due to an effect called thermal runaway which can occur in the exothermic reaction of Li in the charging process.

### BRIEF SUMMARY

Embodiments of the subject invention provide new and novel methods and devices to control the temperature inside lithium ion (Li-ion) batteries to avoid their combustion. Specifically, nanoparticles with a melting point near 80° C. and high specific latent heat can be used as an additive to the electrolyte or the electrodes of Li-ion batteries. The excess heat inside a rechargeable battery can be absorbed by the nanoparticles to limit the temperature and avoid thermal runaway process in the batteries. The nanoparticles can be made from organic or mineral materials with or without a protective shell.

Embodiments of the subject invention use nanoparticles as an additive to the electrolyte of electrodes of Li-ion batteries. The nanoparticles are not necessarily active at elevated temperature, but employ the high specific latent heat of the additives to limit the battery temperature. The constant temperature of the phase transition in the materials decouples the connection between heat produced by the battery reactions and the battery temperature.

A suspension of solid phase-change particles with a melting point around 80° C. can be added to the electrolyte of the battery or employed in the structure of the electrodes. At low temperatures, the phase change material is in solid form. Once the temperature reaches the particular melting point of the material, the nanoparticles start absorbing the heat for melting. However, the battery temperature is kept constant at the melting point inhibiting the thermal runaway. The nanoparticles can also be wrapped in a shell to avoid damaging the electrolyte when the phase change material is melted.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a diagram illustrating the process showing the change of polymer coated phase change material (PCM) in a lithium ion battery.

### DETAILED DESCRIPTION

Embodiments of the subject invention provide new and novel methods and devices to control the temperature inside Li-ion batteries and avoid combustion of the batteries. Nanoparticles with a melting point near 80° C. and high specific latent heat to can be introduced to a Li-ion battery as an additive to the electrolyte or the electrodes. As the battery functions and heat is produced, excess heat inside the battery can be absorbed by the nanoparticles and limit the temperature. Phase change materials can be selected to limit temperature to a pre-determined threshold amount in order to avoid a thermal runaway process. By limiting the temperature to a threshold amount, degradation of performance and destruction of the batteries can be avoided. The nanoparticles can be made from organic or mineral materials with or without a protective shell.

The mechanism of charge storage in Li-ion batteries dictates the structure of the battery, especially the electrodes' structure. For efficient charge storage and the battery lifetime, the charging process is very critical; particularly the current density during the charging cycle has to be limited. Otherwise, the electrode structure would be damaged. Also, such damage can occur when a battery is short circuited. While a damaged electrode can potentially be a hazard for the battery, the main reason for combustion of a battery is due to an effect called thermal runaway that can occur in an exothermic reaction of Li in the charging process.

An exothermic reaction is a reaction that releases energy. As the rate of an exothermic chemical reaction increases, it is related to an increase of temperature; and as an exothermic reaction goes out of control the rapid increase in temperature eventually exploding/catching fire. Considering that a battery is a sealed device, the thermal runaway can also generate gas inside the cell, building up a high pressure and consequently causing explosion. Li-ion batteries can remain functional if the cell temperature remains below a threshold temperature. Once the threshold temperature is surpassed, controlling the reaction rate can be difficult due to the thermal runaway effect. There are various solutions to inhibit the thermal runaway in a Li-ion battery, which include: (1) safety vents, which can vent the generated gas for avoiding the process of building up pressure and increasing temperature; (2) thermal fuses, which can disconnect the circuit before the cell temperature reaches the threshold value; (3) circuit breakers, which are similar to thermal fuses, but apply an automated switch to disconnect the battery from the circuit to shut down the electric current for inhibiting temperature rise; (4) positive thermal coefficient (PTC) elements for limiting the charging/discharging current, which, instead of interrupting the current, PTCs can be used to limit the current passing through the electrodes, thereby limiting the temperature in the cell; (5) shutdown separators, in which an ion transparent membrane between anode and cathode of a battery can become clogged at a relatively low melting point, shutting down the ion transport before occurrence of the thermal runaway; (6) non-flammable electrolytes, which extend the temperature limit at which the electrode or the sealant is destroyed, but which also lower the efficiency of the batteries; (7) redox shuttles, which protect the batteries under overcharging conditions because Li ions would not participate in any further electrochemical reaction when the cell is fully charged and still connected to a charger; and (8) shutdown additives, which is an approach based on adding chemicals to the electrolyte of a cell in a way that the added chemicals are passive at low temperatures but become active at high temperatures, the active mode of the additives suppressing the thermal runaway effect by either releasing some gas to cool down the electrolyte or solidifying the electrolyte to shut down the Li ion transport.

The temperature of the battery needs utmost care for thermal control and management. Generally, lithium ion battery operating range is from 20-40° C. for optimizing the performance and life. A well designed battery can minimize the temperature gradients occurring due to each cell in stacks, but is unable to eliminate the temperature gradients allowing the temperature of the battery to rise while charging and discharging. The heat generation of the battery is transient in nature and is state of charge (SOC) dependent. Thermal runaway can be caused by the battery overcharging, overheating, mechanical impact, or a short circuit occurring at either of the internal and external circuits. In fact, the overcharge causes Li-ion cell to be severely damaged based on used materials, where the electrolyte generates gas by decomposing. The reaction due to overcharging can increase temperature above 100° C.

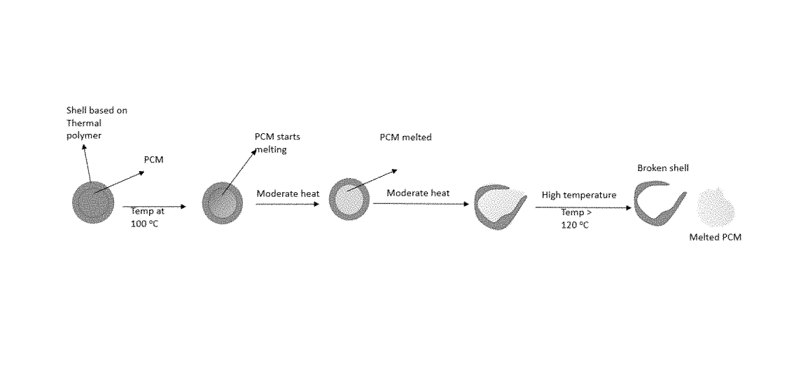

Embodiments of the subject invention can control the temperature of a rechargeable lithium ion battery cell by introducing a polymer coated phase change material into the electrolyte and/or electrode. FIG. 1 illustrates the change process of a polymer coated material (PCM) in a battery with rise in temperature. The PCM is encapsulated in a thermal polymer shell. As the battery continues to emit heat the overall battery temperature rises. The solid PCM absorbs the heat and, once a threshold temperature is reached, the PCM begins to melt. The shell material can be chosen such that it has a higher melting point than the PCM. As seen in FIG. 1, shell structure degrades and the melted PCM is allowed to escape. The electrolyte can be the nanoparticles.

Examples of PCMs and their associated melting point temperatures are shown in Table 1. Materials used to encapsulate the PCMs include polymers, homopolymers, copolymers, or blends of the polymers; polyamides such as Nylon 6, Nylon 6/6; polyimides, polycarbonates, polycaprolactone, polyflourocarbons, polyurethanes, polystyrene, polymethyl styrene, and polyarylates, as seen in Table 2.

TABLE 1
Examples of Phase Change Materials

| No. | Phase Change Material | Melting Point (° C.) |
|---|---|---|
| 1 | Propylene Carbonate | 102 |
| 2 | Low Density Polyethylene | 120 |
| 3 | High Density Polyethylene | 130 |
| 4 | Urea | 133 |
| 5 | Dimethyl terephthalate | 142 |
| 6 | Glucose | 146 |
| 7 | Adipic acid | 152 |
| 8 | Hydroquinone | 172 |
| 9 | Aluminum Chloride | 192 |
| 10 | Myo-inositol | 225 |

TABLE 2
Examples of Phase Change Materials that melt in 100° C. to 250° C.

| | | Melting |
|---|---|---|
| | | temperature |
| Polymer | Structure | (° C.) |
| Cellulose | 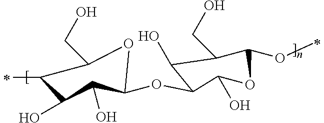 | 110-125 |
| Low density polyethylene | 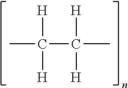 | 109-125 |
| High density polyethylene | 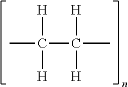 | 130-135 |
| polybutylene | 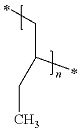 | 126-135 |
| Polycarbonate | 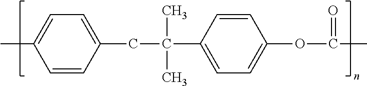 | 215-230 |
| polypropylene | 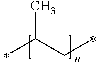 | 130-170 |
| Poly(vinylidene chloride) | 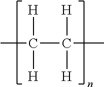 | 210 |
| Poly(vinylidene fluoride) | 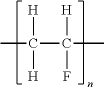 | 160-170 |
| Nylone 11 | 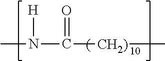 | 200-260 |
| Polyether sulfone (PES) | 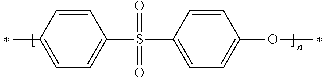 | 343-377 |
| Polyetherimide (PEI) | 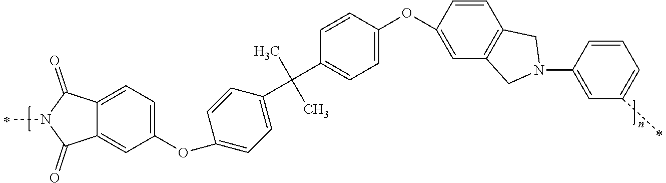 | 204-232 |
| poly ether ether ketone (PEEK) | 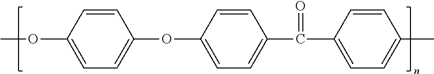 | 340 |
| Polybenzimidazole | 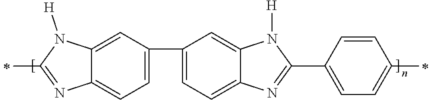 | 400 |
| poly(methyl methacrylate) (PMMA) | 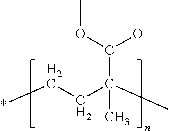 | 160 |
| Acrylonitrile butadiene | (C₈H₈•C₄H₆•C₃H₃N)ₙ | 220 |
| styrene | | |

The subject invention includes, but is not limited to, the following exemplified embodiments.

### Embodiment 1

A method for controlling material temperature, the method comprising: combining a polymer coated phase change material with a material in need of thermal regulation.

### Embodiment 2

The method of embodiment 1, wherein the material in need of thermal regulation includes a component of a lithium ion battery.

### Embodiment 3

The method according to any of embodiments 1-2, wherein the phase change material is nanoparticles.

### Embodiment 4

The method according to any of embodiments 1-3, further comprising combining the phase change material with an electrode component of a lithium ion battery.

### Embodiment 5

The method according to any of embodiments 1-4, further comprising combining the phase change material with an electrolyte component of a lithium ion battery.

### Embodiment 6

The method according to any of embodiments 1-5, wherein the phase change material has a melting point of 80° C. or greater.

### Embodiment 7

The method according to any of embodiments 1-6, wherein the phase change material includes one or more of the following: propylene carbonate, low density polyethylene, high density polyethylene, urea dimethyl terephthalate, glucose, adipic acid, hydroquinone, aluminum chloride, myo-inositol, urea: CO(NH₂)₂, paraffin natural wax 106 (Russia), erythrol: C₄H₁₀O₄, solder: 66.7% tin/33.7% lead, Bi 11.1% and tin 88.9%; Tin Solar Salt: 40 wt % KNO3/60% NaNO3, and polystyrene, 48% Ca(NO₃)₂/45% KNO₃/7% NaNO₃.

### Embodiment 8

The method according to any of embodiments 1-7, further comprising encapsulating the phase change material inside a polymer coating encapsulating material that is different than the phase change material.

### Embodiment 9

The method according to embodiment 8, wherein the encapsulating material has a melting point of 120° C. or greater.

### Embodiment 10

The method according to any of embodiments 8-9, wherein the encapsulating material includes one or more of the following: polybutylene, polycarbonates, polypropylene, poly(vinylidene chloride), poly(vinylidene fluoride), Nylone 11, polyether sulfone (PES), polyetherimide (PEI), poly ether ether ketone (PEEK), polybenzimidazole, poly(methyl methacrylate) (PMMA), acrylonitrile, butadiene styrene; homopolymers, copolymers, or blends of the polymers; polyamides, Nylon 6, Nylon 6/6, polyimides, polycaprolactone, polyflourocarbons, polyurethanes, polystyrene, polymethyl styrene, and polyarylates.

### Embodiment 11

A temperature-controlled Li-ion battery comprising:

a first phase change material incorporated into an electrolyte component of the Li-ion battery.

### Embodiment 12

The temperature-controlled Li-ion battery of embodiment 11, further comprising a second phase change material incorporated into an electrode of the Li-ion battery, and wherein the second phase change material is the same as or different from the first phase change material.

### Embodiment 13

The temperature-controlled Li-ion battery according to any of embodiments 11-12, wherein at least one of the first and second phase change materials has a melting point of 80° C. or greater.

### Embodiment 14

The temperature-controlled Li-ion battery according to any of embodiments 11-13, wherein the phase change material includes one or more of the following: propylene carbonate, low density polyethylene, high density polyethylene, urea dimethyl terephthalate, glucose, adipic acid, hydroquinone, aluminum chloride, myo-inositol, urea: CO(NH₂)₂, propylene carbonate, paraffin natural wax 106 (Russia), erythrol: C₄H₁₀O₄, solder: 66.7% tin/33.7% lead, Bi 11.1% and tin 88.9%; Tin Solar Salt: 40 wt % KNO₃/60% NaNO₃, and polystyrene, 48% Ca(NO₃)₂/45% KNO₃/7% NaNO₃.

### Embodiment 15

The temperature-controlled Li-ion battery according to any of embodiments 11-14, wherein the phase change material is encapsulated inside a polymer coating encapsulating material that is different than the phase change material.

### Embodiment 16

The temperature-controlled Li-ion battery according to any of embodiments 11-15, wherein the encapsulating material has a melting point of 120° C. or greater.

### Embodiment 17

The temperature-controlled Li-ion battery according to any of embodiments 11-16, wherein the encapsulation material includes one of more of the following polybutylene, polycarbonates, polypropylene, poly(vinylidene chloride), poly(vinylidene fluoride), Nylone 11, polyether sulfone (PES), polyetherimide (PEI), poly ether ether ketone (PEEK), polybenzimidazole, poly(methyl methacrylate) (PMMA), acrylonitrile, butadiene styrene; homopolymers, copolymers, or blends of the polymers; polyamides, Nylon 6, Nylon 6/6, polyimides, polycaprolactone, polyflourocarbons, polyurethanes, polystyrene, polymethylstyrene, and polyarylates.

All patents, patent applications, provisional applications, and publications referred to or cited herein are incorporated by reference in their entirety, including all FIGURES and tables, to the extent they are not inconsistent with the explicit teachings of this specification.

Following are examples that illustrate procedures for practicing the invention. These examples should not be construed as limiting. All percentages are by weight and all solvent mixture proportions are by volume unless otherwise noted.

### Example 1

The use of thermoplastic for encapsulation of the PCMs be remolded due to intermolecular interactions spontaneously reform upon cooling. A shell material/pouch/container can be a high temperature thermoplastic polymer such as polyimide/polystyrene. The phase change material can be encapsulated by thermal extrusion process. Polyimide will be stable up to 300-350° C. and the polystyrene will be stable at 240° C.

### Example 2

The heat developed within a Li-ion battery is absorbed by the phase change material and melts at a temperature greater than 80° C., however, a temperature greater than 120° C. will break the polymer shell and the PCM is released and mixed with electrolyte to insulate the electrolyte.

The PCM can be paraffin, poly(ethylene terephthalate), utectic of (NaCl+KCl+CaCl₂), n-Pentacontane, low density polyethylene, xylitol, D-Sorbitol, high density polyethylene, urea dimethyl terephthalate, glucose, adipic acid, hydroquinone, aluminum chloride, myo-inositol, urea: CO(NH₂)₂, propylene carbonate, paraffin natural wax 106 (Russia), erythrol: C₄H₁₀O₄, solder: 66.7% tin/33.7% lead, Bi 11.1% and tin 88.9%; Tin Solar Salt: 40 wt % KNO₃/60% NaNO₃, or polystyrene, 48% Ca(NO₃)₂/45% KNO₃/7% NaNO₃.

It should be understood that the examples and embodiments described herein are for illustrative purposes only and that various modifications or changes in light thereof will be suggested to persons skilled in the art and are to be included within the spirit and purview of this application.

All patents, patent applications, provisional applications, and publications referred to or cited herein (including those in the “References” section) are incorporated by reference in their entirety, including all FIGURES and tables, to the extent they are not inconsistent with the explicit teachings of this specification.

### REFERENCES

[1] J. Wen, Y. Yu, and C. Chen, “A review on lithium-ion batteries safety issues: existing problems and possible solutions,” Materials express, vol. 2, pp. 197-212, 2012.
[2] P. Balakrishnan, R. Ramesh, and T. P. Kumar, “Safety mechanisms in lithium-ion batteries,” Journal of Power Sources, vol. 155, pp. 401-414, 2006.
[3] Z. Chen, P.-C. Hsu, J. Lopez, Y. Li, J. W. To, N. Liu, et al., “Fast and reversible thermoresponsive polymer switching materials for safer batteries,” Nature Energy, vol. 1, p. 15009, 2016.
[4] S. S. Zhang, “A review on electrolyte additives for lithium-ion batteries,” Journal of Power Sources, vol. 162, pp. 1379-1394, 2006.
[5] H. Berg, Batteries for Electric Vehicles: Materials and Electrochemistry: Cambridge University Press, 2015.

What is claimed is:

1. A method for controlling material temperature, the method comprising:
combining a polymer coated phase change material with a material in need of thermal regulation.

2. The method of claim 1, wherein the material in need of thermal regulation includes a component of a lithium ion battery.

3. The method of claim 1, wherein the phase change material is nanoparticles.

4. The method of claim 1, further comprising combining the phase change material with an electrode component of a lithium ion battery.

5. The method of claim 1, further comprising combining the phase change material with an electrolyte component of a lithium ion battery.

6. The method of claim 1, wherein the phase change material has a melting point of 80° C. or greater.

7. The method of claim 1, wherein the phase change material includes one or more of the following: propylene carbonate, low density polyethylene, high density polyethylene, urea dimethyl terephthalate, glucose, adipic acid, hydroquinone, aluminum chloride, myo-inositol, urea: CO(NH₂)₂, paraffin natural wax 106 (Russia), erythrol: C₄H₁₀O₄, solder: 66.7% tin/33.7% lead, Bi 11.1% and tin 88.9%; Tin Solar Salt: 40 wt % KNO₃/60% NaNO₃, and polystyrene, 48% Ca(NO₃)₂/45% KNO₃/7% NaNO₃.

8. The method of claim 1, further comprising encapsulating the phase change material inside a polymer coating encapsulating material that is different than the phase change material.

9. The method according to claim 8, wherein the encapsulating material has a melting point of 120° C. or greater.

10. The method of claim 8, wherein the encapsulating material includes one or more of the following: polybutylene, polycarbonates, polypropylene, poly(vinylidene chloride), poly(vinylidene fluoride), Nylone 11, polyether sulfone (PES), polyetherimide (PEI), poly ether ether ketone (PEEK), polybenzimidazole, poly(methyl methacrylate) (PMMA), acrylonitrile, butadiene styrene; homopolymers, copolymers, or blends of the polymers; polyamides, Nylon 6, Nylon 6/6, polyimides, polycaprolactone, polyflourocarbons, polyurethanes, polystyrene, polymethylstyrene, and polyarylates.

11. A temperature-controlled Li-ion battery comprising:
a first phase change material incorporated into an electrolyte component of the Li-ion battery.

12. The temperature-controlled Li-ion battery of claim 11, wherein the battery further comprises a second phase change material incorporated into an electrode of the Li-ion battery, and wherein the second phase change material is the same as the first phase change material.

13. The temperature-controlled Li-ion battery of claim 12, wherein at least one of the first and second phase change materials has a melting point of 80° C. or greater.

14. The temperature-controlled Li-ion battery of claim 11, wherein the phase change material includes one or more of the following: propylene carbonate, low density polyethylene, high density polyethylene, urea dimethyl terephthalate, glucose, adipic acid, hydroquinone, aluminum chloride, myo-inositol, urea: CO(NH₂)₂, propylene carbonate, paraffin natural wax 106 (Russia), erythrol: C₄H₁₀O₄, solder: 66.7% tin/33.7% lead, Bi 11.1% and tin 88.9%; Tin Solar Salt: 40 wt % KNO₃/60% NaNO₃, and polystyrene, 48% Ca(NO₃)₂/45% KNO₃/7% NaNO₃.

15. The temperature-controlled Li-ion battery of claim 11, wherein the phase change material is encapsulated inside a polymer coating encapsulating material that is different than the phase change material.

16. The temperature-controlled Li-ion battery of claim 15, wherein the encapsulating material has a melting point of 120° C. or greater.

17. The temperature-controlled Li-ion battery of claim 15, wherein the encapsulating material includes one or more of the following: polybutylene, polycarbonates, polypropylene, poly(vinylidene chloride), poly(vinylidene fluoride), Nylone 11, polyether sulfone (PES), polyetherimide (PEI), poly ether ether ketone (PEEK), polybenzimidazole, poly(methyl methacrylate) (PMMA), acrylonitrile, butadiene styrene; homopolymers, copolymers, or blends of the polymers; polyamides, Nylon 6, Nylon 6/6, polyimides, polycaprolactone, polyflourocarbons, polyurethanes, polystyrene, polymethylstyrene, and polyarylates.

18. The temperature-controlled Li-ion battery of claim 11, wherein the battery further comprises a second phase change material incorporated into an electrode of the Li-ion battery, and wherein the second phase change material is different from the first phase change material.
